(19) United States
(12) Patent Application Publication
(10) Pub. No.: US 2019/0230163 A1
(43) Pub. Date: Jul. 25, 2019

(54) CELLULAR CENTREX: DUAL-PHONE CAPABILITY

(71) Applicant: Avaya Inc., Santa Clara, CA (US)

(72) Inventor: David Chavez, Broomfield, CO (US)

(21) Appl. No.: 15/877,071

(22) Filed: Jan. 22, 2018

(51) Int. Cl. H04L 29/08; H04W 4/21; G06Q 50/00

(52) U.S. Cl. CPC H04L 67/125; G06Q 50/01; H04W 4/21

(57) ABSTRACT

Embodiments of the disclosure provide a communication system and method. In some embodiments, a mobile network core is provided with a communication interface that establishes enables the receipt of incoming calls, a microprocessor, and memory that stores instructions that, when executed by the microprocessor, enable the microprocessor to identify an incoming call as being associated with a first persona or a second persona and, based on whether the incoming call is identified as being associated with the first persona or the second persona, automatically causes a user interface of a mobile device associated with the incoming call to present a particular set of applications from a plurality of applications to a user of the mobile device.

### FIELD OF THE DISCLOSURE

Embodiments of the present disclosure relate generally to communication methods and communication systems.

### BACKGROUND

Since the widespread adoption of mobile phones, many business people opt to take work calls on personal devices. Allowing employees to take calls on a personal device is a way to increase productivity and availability. Additionally, with steady improvements in remote access, many business people choose to work from home. With increased mobility and flexibility, the demand for communications services has also changed. There have been some crossover features including special ringtones and voicemail transcription to differentiate personal and work calls, but not all features and interfaces are extended. Unfortunately, this can create dilution or loss of features and a lack of separation. The feature dilution of lack of separation can cause frustration for personal calls and limit effectiveness on business calls.

### BRIEF SUMMARY

Embodiments of the disclosure solves these and other issues by providing a call detection feature. The business call detection feature, among other things, allows calls to be classified into one of multiple different personas. As an example, incoming calls can be separated into business and personal calls. Depending upon the classification of the incoming call different user interfaces are rendered on a per-call basis accordingly. Embodiments of the present disclosure harken back to and build on the idea of a central exchange (centrex or feature lines) where extensions provide certain functions and function identically regardless of location.

In accordance with at least some embodiments, a system and method are provided by which a cellular carrier engages a service that works on a call-by-call basis. The disclosed method can determine whether a call is likely a business call or not a business call. If the call is identified as a business call, the system can apply business rules and signal to the cell phone to render a business user interface (UI). If the call was not identified as a business call (at least with a predetermined amount of confidence), no business services would be extended. The UI provided would simply be the consumer UI (e.g., a default UI). One aspect of the present disclosure would be to highlight a client to present a UI business look and feel.

Embodiments of the present disclosure will be primarily discussed in connection with mobile services, but in an additional embodiment, it can also be extended for a fixed phone. In some embodiments, when a call or a message for a subscribing party is received by a mobile core, the mobile core can invoke an application (e.g., via SIP-ISC) to determine if the call is a business call or a personal call. This can be done by checking the originator's handle with known addresses for known customers, partners, vendors, providers, and prospects. If there is a match when the call is processed, a business communications server may then be invoked (can also be via SIP-ISC). The business communication server can provide all business features, support business rulesets, and the call/message may be marked with business priority. In the absence of a match, the call/message may be marked with personal priority or some other priority. It should be appreciated that more than two different personas can be supported by embodiments of the present disclosure. For instance, rather than a simple bifurcation between business and personal personas, embodiments of the present disclosure can also support sub-groupings of personas like a family persona, a friends persona, a work/colleague persona, a work/client persona, a hobby persona, etc.

When a device receives the incoming call/message, the device may render business priority with an appropriate UI where supported business functions can be provided. Alternatively, if the call/message is assigned a personal priority, the device may render a consumer UI. A screen gesture can be supported, allowing the device user to switch to the other UI if desired.

For outbound calls/messages, the subscribing party can use either UI. Once the call/message reaches the mobile core, the application checks the destination address against the business list as before. The application will indicate appropriately back to the subscribing party whether the call/message is business or personal priority. If the priority should be different from the client originally selected, it will switch to the appropriate UI. In the case of a business call/message, the business communications server will be invoked before processing the call/message so that all business functions and rulesets will be respected and available.

In accordance with at least some embodiments, a system and method are disclosed which provide a UI rendering on a call-by-call basis based on call type operable to apply personal applications and a personal UI to personal calls and a business UI, business rules, and other business-specific call features to a business call.

One aspect of the present disclosure provides a method that includes:

receiving a notification of an incoming call for at least one callee;

determining whether the incoming call is associated with a first persona or a second persona for the at least one callee;

based on whether the incoming call is identified as being associated with the first persona or the second persona, causing a mobile device to present a particular set of applications from a plurality of applications via a user interface of the user device, wherein an application not belonging to the particular set of applications has an associated icon hidden from presentation via the user interface.

Another aspect of the present disclosure provides a mobile network core that includes:

a communication interface that enables receipt of incoming calls;

a microprocessor; and

memory that stores instructions that, when executed by the microprocessor, enable the microprocessor to identify an incoming call as being associated with a first persona or a second persona and, based on whether the incoming call is identified as being associated with the first persona or the second persona, automatically causes a user interface of a mobile device associated with the incoming call to present a particular set of applications from a plurality of applications to a user of the mobile device.

### BRIEF DESCRIPTION OF THE DRAWINGS

FIG. 1 is a block diagram illustrating components of a system according to one embodiment;

FIG. 2 is a block diagram illustrating components of a user device according to one embodiment;

FIG. 3 is a block diagram illustrating components of a server implementing a persona presentation service according to one embodiment;

FIG. 4 is a block diagram depicting a data structure used in connection with providing a persona presentation service according to one embodiment;

FIG. 5A illustrates a user interface of a user device in a first presentation state according to embodiments of the present disclosure;

FIG. 5B illustrates a user interface of a user device in a second presentation state according to embodiments of the present disclosure;

FIG. 5C illustrates a user interface of a user device in a third presentation state according to embodiments of the present disclosure;

FIG. 6 is a flow diagram depicting a method of providing a persona presentation service according to embodiments of the present disclosure;

FIG. 7 is a flow diagram depicting a method of operating a user device in response to receiving a call notification message according to embodiments of the present disclosure;

FIG. 8 is a flow diagram depicting an alternative method of operating a user device according to embodiments of the present disclosure;

FIG. 9A illustrates a user interface of a user device in a first presentation state according to embodiments of the present disclosure; and

FIG. 9B illustrates a user interface of a user device in a second presentation state according to embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments of the disclosure provide systems and methods for persona-based presentation services, either from a mobile network core or directly from an application operating on a user device being carried by a caller or callee associated with a call. While the flowcharts will be discussed and illustrated in relation to a particular sequence of events, it should be appreciated that changes, additions, and omissions to this sequence can occur without materially affecting the operation of the disclosed embodiments, configuration, and aspects.

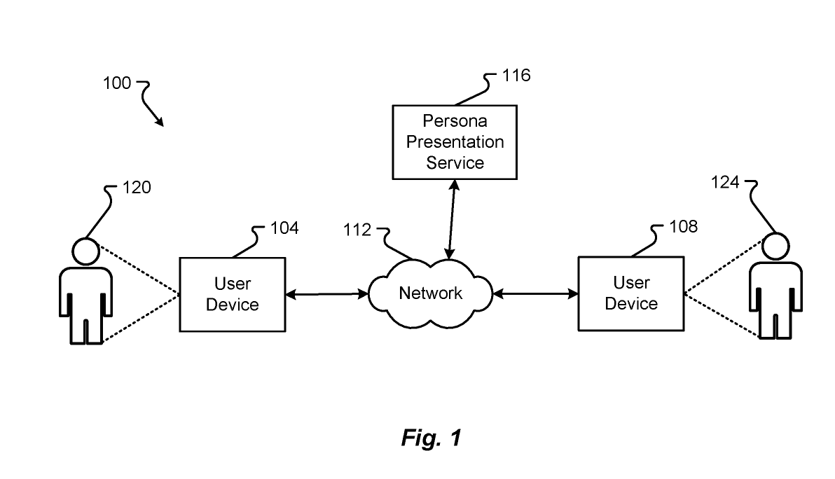

With reference now to FIG. 1, an illustrative communication system 100 will be described in accordance with at least some embodiments of the present disclosure. As shown in FIG. 1, the system 100 may include a first user device 104 and second user device 108 in communication with one another via a communication network 112. In one non-limiting embodiment, one or both user devices 104, 108 may correspond to mobile communication devices (e.g., smartphones, tablets, wearable devices, etc.) that are carried by users 120, 124 respectively. In such a scenario, the user devices 104, 108 may be in communication with one another through one or more mobile networks, that may be operated by one or more mobile network operators (MNOs). Accordingly, the network 112 may include a cellular or other wireless network and the user devices 104 and/or 108 can include smartphones, tablets, laptop computers, wearable devices, or any other portable electronic device configured to communicate over the network 112. It should be understood that while only two devices 104, 108 are illustrated here for the sake of simplicity, any number of devices of different types may be connected with the network 112 at any given time.

The network 112 can also include an Internet Protocol (IP) Multimedia Subsystem (IMS) framework providing Internet and/or other data services to the user devices 104, 108 over the network 112. Generally speaking, the IMS framework of the network 112 can utilize Session Initiation Protocol (SIP) and/or other Internet Engineering Task Force (IETF) standard protocols to provide any number of IP multimedia services including but not limited to Voice over IP (VoIP) calling, media streaming, web access, etc. Alternatively or additionally, the network 112 may include a distributed computing network such as the Internet or some other packet-based communication network.

The communication system 100 may further include a persona presentation service 116 that is connected to the communication network 112. In some embodiments, the persona presentation service 116 may be provided by one or multiple servers that are in communication with the network 112. As a more specific example, the persona presentation service 116 may provide one or both user devices 104, 108 with persona-based presentation services and features during calls or communication sessions between the devices 104, 108. More specifically, when user 120 (e.g., a caller) places a call or other type of communication request to user 124 (e.g., a callee), the persona presentation service 116 may be configured to intercept one or more messages between the user devices 104, 108 and then insert presentation instructions into such messages, thereby enabling the callee's user device 108 to provide a presentation of applications (and icons associated therewith) that are specifically designed to help the callee 124 during the call with the caller 120. In a specific example, the persona presentation service 116 may enable certain applications or icons to be presented via the callee's 124 user device 108 based on a persona assigned to the communication session. Additional details of such a persona-based presentation service will be described in further detail herein.

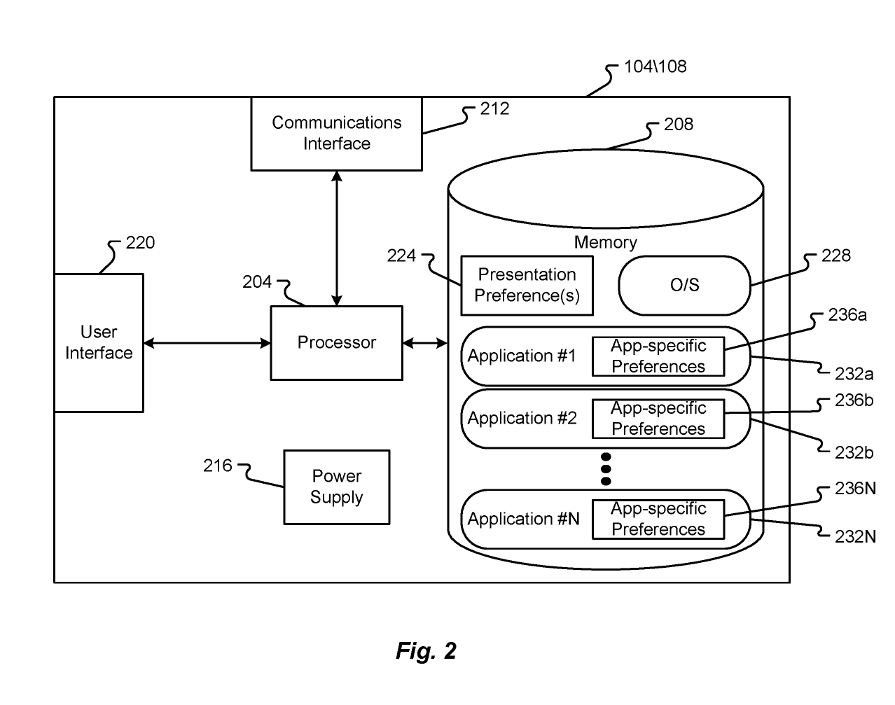

With reference now to FIG. 2, additional details of a user device 104, 108 will be described in accordance with at least some embodiments of the present disclosure. Although the devices 104, 108 are referred to generally as user devices, it should be appreciated that the user device(s) 104, 108 may correspond to mobile communication devices, wearable communication devices, computers, laptops, tablets, Personal Digital Assistants (PDAs), etc.

The user device 104, 108 is shown to include a processor 204, memory 208, a communication interface 212, a power supply 216, and a user interface 220. In some embodiments, all of the components of user device 104, 108 are provided within a common device housing and are connected via a one or multiple circuit boards.

The processor 204 may correspond to one or multiple processing circuits. In some embodiments, the processor 204 may include a microprocessor, an Integrated Circuit (IC) chip, an ASIC, or the like. The processor 204 may be configured with a plurality of logic circuits or circuit elements that enable the processor 204 to execute one or more instructions or instruction sets maintained in memory 208. Alternatively or additionally, the processor 204 may be configured to execute instructions received via the communications interface 212. As an example, the processor 204 may be configured to execute one or more drivers that are specifically provided for the communications interface 212 and/or the user interface 220.

The memory 208 is shown to be in communication with the processor 204. The memory 208 may include any type or combination of computer memory devices. Non-limiting examples of memory 208 include flash memory, volatile memory, non-volatile memory, RAM, NVRAM, SRAM, ROM, EEPROM, etc. As can be appreciated, the types of devices used for memory 208 may depend upon the nature and type of data stored in memory 208.

In the depicted embodiment, the memory 208 includes one or a plurality of presentation preferences 224, an operating system (O/S) 228, and a plurality of applications 236a-N. A user of the device 104, 108 may be enabled to access and utilize the applications 236a-N via use of the O/S 228. Examples of an O/S 228 include Apple iOS, Android OS, Blackberry OS, Windows OS, Palm OS, Open WebOS, etc. In some embodiments, the O/S 228 provides a display of icons that are presented via the user interface 220. Some or all of the icons may be selectable by the user of the user device 104, 108 to access routines or features provided by applications 236a-N. In some embodiments, each application 236a-N has a specific icon associated therewith that is presented via a home screen of the O/S 228. When that specific icon is selected by a user, the user interface 220 of the user device 104, 108 may present specific data and graphics associated with the application.

The way in which data and graphics for a particular application are presented may be controlled by the application-specific preferences 232a-N associated with each application 236a-N. For instance, the first application 236a may have data and graphics presented for the first application 236a when an icon of the first application 236a is selected through the O/S 228. Once the first application 236a is being presented and accessed by the user, the display of information on the user interface 220 may be at least partially driven by the application-specific preferences 232a. The application-specific preferences 232b-232N will not be used to control a presentation of data or graphics via the user interface 220 unless and until their associated application 236b-N has been selected for use via the O/S 228. Until such a selection is made, the application-specific preferences 232b-N are generally ignored when providing visual/audible presentations via the user interface 220. Examples of applications 236a-N and their instructions sets that may be maintained in memory 208 include calling applications, web browsing applications, social networking applications, gaming applications, camera applications, photo applications, video applications, messaging applications, word-processing applications, calendaring applications, contact management applications, and any other known type of application. In some embodiments, the applications 236a-N work in conjunction with the O/S 228 via one or more Application Programming Interfaces (APIs) that are exposed to the applications by the O/S 228. The APIs may further enable the applications 236a-N to have access to other hardware components of the mobile device 104, 108 (e.g., communication interface, user interface, etc.).

Whereas the application-specific preferences 232a-N are used to present data and graphics for a particular associated application 236a-N, the presentation preferences 224 are used by the O/S 228 to present the icons of the applications 236a-N and provide other presentation rules that are application agnostic (e.g., applied equally across all applications and/or applied to presentations of information not related to applications). In some examples, the presentation preferences 224 may dictate which application icons are presented on the user interface 220, where application icons are presented on the user interface 220, when application icons are presented on the user interface 220, sound preferences, notification preferences, basic color presentation themes, background settings, screen saver preferences, default font size, etc. As can be appreciated, the presentation preferences 224 may be followed hierarchically with respect to the application-specific preferences 232a-N. Said another way, the presentation of application data and graphics may be required to comply with the application-specific preferences 232a-N in addition to following presentation preferences 224. In the event that an application-specific preference 232a-N conflicts with a rule in the presentation preference(s) 224, the presentation preference(s) 224 may dictate the ultimate rule for presentation.

The presentation preferences 224 may also control the way that certain data and graphics are presented for the O/S 228 via the user interface 220. As will be discussed in further detail herein, the presentation preferences 224 may be modified or customized based on a persona of an incoming call/communication. Thus, the presentation preferences 224 may be configured to have multiple different instruction sets that are followed depending upon a persona associated with and/or assigned to an incoming call received at user device 104, 108. As will be discussed in further detail herein, a persona for a call may be determined, at least in part, based on a context of the call, an identification of the caller, an identification of the callee, a communication media (e.g., voice, video, text, social message, etc.) used for the call, a location of the callee's user device, a location of the caller's user device, a time of day, a day of week, whether the caller and/or callee are scheduled for vacation, or combinations thereof. Thus, the presentation preference(s) 224 may include one or more rules associated with presenting data via the user interface 220 that are followed by the O/S 228. As a non-limiting example, if an incoming call or communication is associated with a first persona (e.g., a work persona for the callee), then the presentation preference(s) 224 may cause the O/S 228 to present a first set of icons via the user interface, where the first set of icons are associated with a first set of applications (e.g., a set of applications that are determined to be “work” applications). On the other hand, if an incoming call or communication is associated with a second persona (e.g., a non-work or personal persona for the callee), then the presentation preference(s) 224 may cause the O/S 228 to present a second set of applications (e.g., a set of applications that are determined to be “personal” applications). The presentation of icons may be provided to the user via the user interface 220. In some embodiments, there may be at least one application (and therefore one icon) that belongs to the first set of applications and does not belong to the second set of applications. Conversely, there may be at least one application (and therefore one icon) that belongs to the second set of applications and does not belong to the first set of applications.

The communications interface 212 provides hardware and drivers that enable the user device 104, 108 to connect with the network 112, receive communications from the network 112, and/or provide communications to the network 112 for delivery to another user device. In some embodiments, the communications interface 212 includes a wired and/or wireless network adapter. Non-limiting examples of a communications interface 212 include an antenna and associated driver (e.g., a WiFi or 802.11N antenna and/or driver), an Ethernet card and/or driver, a serial data port (e.g., a USB port) and/or driver, a Bluetooth or BLE antenna and/or driver, an NFC antenna and/or driver, or any other type of device that facilitates inter-device communications. The communications interface 212 may receive one or more data packets or messages from the communication network 112 and extract data therefrom. The data extracted from the received data packets or messages may be provided to the processor 204 where the data can subsequently be processed using instructions stored in memory 208.

The power supply 216 may correspond to an internal power source and/or adapter for connection with an external power source. In the example of an internal power source, the power supply 216 may correspond to a battery or cell of batteries used to power the various other components of the user device 104, 108. Alternatively or additionally, the power supply 216 may include a power converter or power conditioner that enables power received from an external source (e.g., a 120V AC power source) to be converted into useable DC power that can be supplied to the various components of the user device 104, 108.

The user interface 220 may correspond to a user input device, a user output device, a combination user input/output device, or a number of such devices. As an example of a user input device, the user interface 220 may include a microphone, a button, a physical switch, a camera, an accelerometer, or the like. As an example of a user output device, the user interface 220 may include a speaker, a light, a display screen, a tactile output device (e.g., a haptic feedback device), or the like. As an example of a combination user input/output device, the user interface 220 may include a touch-sensitive display screen that has one or more areas thereof capable of presenting a Graphical User Interface (GUI) element and, if touched or selected by a user, recognizing that the GUI element has been selected by the user.

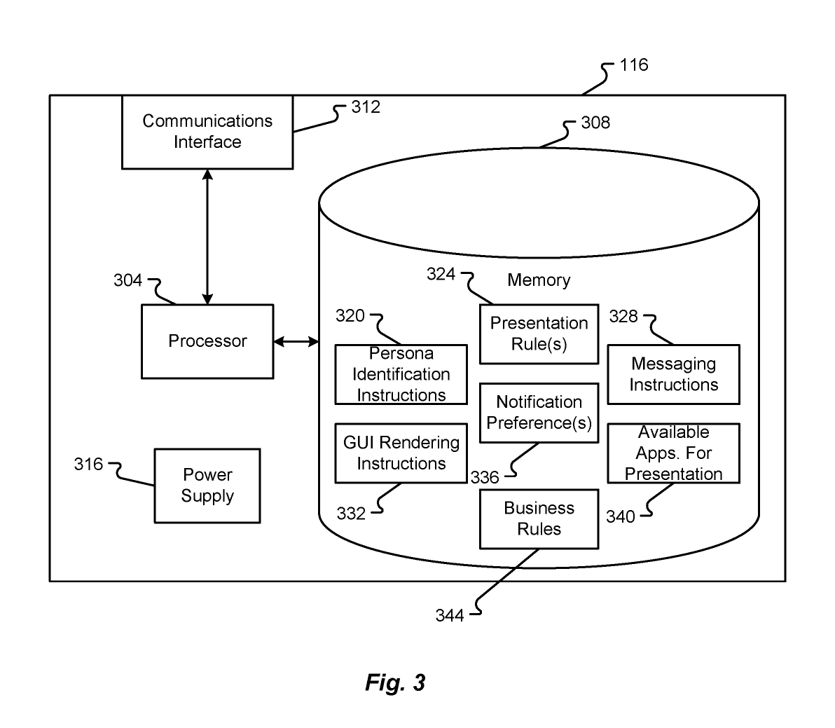

With reference now to FIG. 3, details of a persona presentation service 116, or more specifically a server providing the persona presentation service 116, will be described in accordance with at least some embodiments of the present disclosure. The persona presentation service 116 may be executed by a single server, a plurality or servers, one or more virtual machines operating on a server, a server cluster, or the like. A server may, in some embodiments, have several components similar to a user device 104, 108 except that the server generally does not provide a rich user interface. Rather, the server executing the persona presentation service 116 is shown to include a processor 304, memory 308, a communications interface 312, and a power supply 316. It should be appreciated that a server executing the persona presentation service 116 may be operating as part of a mobile network core (e.g., an IMS core) and, therefore, may provide persona-based personalization services to one or more mobile devices operating as user devices 104, 108. Although certain elements are shown as being provided in memory 308 and not memory 208, it should be appreciated that some or all of the components depicted in FIG. 3 may be provided in a user device 104, 108. Likewise, some or all of the components depicted in FIG. 2 may be provided in a persona presentation service 116 without departing from the scope of the present disclosure.

In some embodiments, the processor 304 may be similar or identical to processor 204. As an example, the processor 304 may include one or more of a microprocessor, an IC chip, an ASIC, or combinations thereof. Likewise, the memory 308 may be similar or identical to memory 208. As an example, the memory 308 may include one or more computer memory devices that may be volatile or non-volatile in nature. The power supply 316 may be similar or identical to power supply 216. As an example, the power supply 316 may correspond to a power converter that is capable of converting AC input power into DC power that is useable by the various components of the server(s) providing the service 116.

Memory 308 is further shown to include instructions that enable the persona presentation service 116 to provide persona-based presentation customization features to one or both user devices 104, 108 when a communication session is being established or has been established between the devices 104, 108. As discussed above, some or all of the instructions stored in memory 308 may be executable by the processor 304 in connection with providing the services described herein.

As some non-limiting examples, the memory 308 may include persona identification instructions 320, presentation rule(s) 324, messaging instructions 328, GUI rendering instructions 332, notification preference(s) 336, and/or available applications for presentation 340. These various instructions, preference, or rules may be provided within a single application stored in memory 308 or they may be separated as shown. In some embodiments, the persona identification instructions 320, when executed by processor 304, enables an incoming call notification message to be analyzed for possible information that can help determine a persona to associate with the call. In the event that the persona identification instructions 320 is not able to positively identify an incoming call notification message as being associated with a particular persona (e.g., at least not within a predetermined tolerance variance), then the persona identification instructions 320 may simply identify the incoming call notification message as being associated with a default persona (which may or may not correspond to a particular persona). In such an example, the persona presentation service 116 may instruct the callee's user device to simply display all applications (and application icons) in a normal/default fashion without accounting for a persona. This particular scenario may be followed when a persona is not determined at least with a predetermined amount of confidence. For example, if a confidence score associated with determining a persona for an incoming call notification message is less than 50%, then the persona identification instructions 320 may not positively identify any persona as being associated with the incoming call. On the other hand, if the persona identification instructions 320 does identify the incoming call as being associated with a particular persona, then that information may be provided to other instructions stored in memory 308 for further processing. Parameters of the incoming call notification message which may be evaluated by the persona identification instructions 320 include, without limitation, caller identification information, callee identification information, caller location, callee location, location of caller's user device, location of callee's user device, time of day, day of week, calendar events for caller and/or callee, etc.

When a persona is determined by the persona identification instructions, the determined persona information is provided to presentation rule(s) 324 to determine what types of presentation instructions should be provided to a user device 104, 108. The messaging instructions 328 may also be invoked to determine whether and to what extent the incoming call notification message received at the service 116 should be modified or replaced so as to enable the call notification message to further include a set of presentation instructions for a user device associated with the callee. More particularly, the presentation rule(s) 324 may help determine which applications and/or icons should be presented via callee's user device 104, 108. This determination may be made based on the persona identified by the persona identification instructions. The presentation rule(s) 324 may also reference the listing of applications available for presentation on the callee's user device 340. Based on this information, the presentation rules 324 may identify a set of applications (or icons) to display in connection with the call notification message.

The presentation rule(s) 324 may further reference the notification preference(s) 336, which may be specific to the callee/caller, to determine how the set of applications (or icons) should be presented on the user interface of the user device. As an example, the presentation rule(s) 324 may further reference GUI rendering instructions 332 to determine the type of user interface rendering instructions to include in the call notification message. As can be appreciated, the call notification message may be updated to include presentation instructions that will be received at the callee's user device and will cause the callee's user device to render applications or icons in a particular way consistent with the presentation rules and based on the determined persona. The presentation instructions may be incorporated within the call notification message, appended to the call notification message (e.g., as an attachment or separate file), or included in one or more headers of the call notification message. Once received at the callee's user device, the set of presentation instructions cause the user device to present a particular set of applications from a plurality of applications (or icons associated with the applications) via a user interface of the user device. In some embodiments, the GUI rendering instructions 332 along with the presentation rules 324 may develop a set of presentation instructions that cause the user interface to present GUI elements of a particular type, in a particular order, and/or in a particular configuration or screen location (which may be different from a default presentation of those GUI elements for the callee's user device).

The presentation rule(s) 324 and notification preferences 336 may define how the incoming call and/or outbound call is alerted (e.g., which visual and/or audible notifications to present via the user device and/or which applications should be automatically opened when the call notification message is received at the user device). The messaging instructions 328 enable the various types of presentation instructions (which may include notification instructions, GUI rendering instructions, and the like) to be sent to the user device (of the callee and/or caller) along with or incorporated within the call notification message prior to the call notification message being sent from the service 116 to the callee's user device and/or caller's user device. The list of applications available for presentation 340 may include a complete listing of the applications 236 resident in memory 208 of the callee's user device or applications available to callee's user device. The list of applications available for presentation 340 may further include the callee's and/or caller's designation of whether a particular application (or icon associated therewith) should be presented for a particular persona. For instance, each application provided in the list of available applications may include a designation of whether that particular application is associated with a first persona, a second persona, a third persona, . . . , an Nth persona, or a combination thereof. This list 340 may be remotely accessible and/or modifiable by the users of user devices 104, 108 without departing from the scope of the present disclosure.

In addition to the presentation rules 324 and notification preferences 336, the memory 308 may further store business rules 344, which can also be selectively applied to calls passing through the network core. In some embodiments, the business rules 344 may define particular actions or network features to invoke when the persona is determined to correspond to a business persona. More specifically, a business entity may define the business rules 344 to be applied to calls having a business persona assigned thereto. Examples of actions or network features that may be invoked with reference to the business rules include, without limitation, call recording, call forwarding, twinning, call extensions, restrictions on international calling, etc. If the call is not positively determined to have a business persona associated therewith, then the business rules 344 may not be applied to the call.

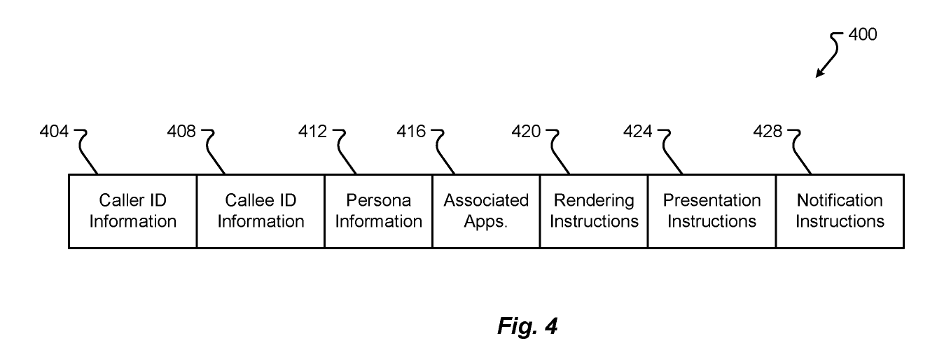

With reference now to FIG. 4, additional details of a data structure 400 used to provide a persona-based presentation customization will be described in accordance with at least some embodiments of the present disclosure. The data structure 400 may correspond to some or all components of a call notification message that can be conveyed from a persona personalization service 116 to a user device 104, 108 (e.g., a callee and/or caller's user device). Some or all of the fields of the data structure 400 may be included in a header of a call notification message, attached to a call notification message, etc. Although embodiments of the present disclosure discuss the call notification message as being associated with a particular “call”, it should be appreciated that a “call” as used herein may correspond to any type of communication between two or more user devices that uses any type of communication medium or combination of media (e.g., voice call, video call, text message, social networking message, etc.). The call may, in some embodiments, correspond to a real-time or near-real-time communication session, but embodiments of the present disclosure are not so limited.

Examples of the data fields that may be provided in data structure 400 include, without limitation, a caller ID information field 404, a callee ID information field 408, a persona information field 412, an associated applications field 416, a rendering instructions field 420, a presentation instructions field 424, and a notification instructions field 428. The fields 420, 424, 428 may be collectively referred to as a set of presentation instructions in that each of the various fields includes one or more parameters, data values, and/or instruction sets used by a user device to modify information presented via a user interface (e.g., visually and/or audibly).

As the name suggests, the caller ID information field 404 may include information that identifies a caller that has initiated a call to the callee. The caller ID information field 404 may reference a caller by his/her alias, an address (e.g., social network name, telephone number, email address, IP address, MAC address, etc.). Similarly, the callee ID information field 408 may include information that identifies a callee that is an intended recipient of an incoming call (e.g., a “call target”). It should be appreciated that where a conference call is being established between a caller and multiple callees, the callee ID information field 408 may include identification information for some or all of the callees associated with the call.

The persona information field 412 may include information used by the persona identification instructions 320 to determine a persona associated with a call. Alternatively or additionally, the persona information field 412 may include outputs of the persona identification instructions 320 (e.g., whether a particular persona has been identified as being associated with the call, a confidence score associated with the persona determination, etc.).

The associated applications field 416 may include a listing of which applications (or icons) should be presented in connection with the incoming call. Alternatively or additionally, the associated applications field 416 may provide a listing of which applications should be obfuscated or hidden from presentation in connection with the incoming call. In some embodiments, the associated applications listed in the field 416 may have their data and/or graphical elements hidden from display just during the call notification or for the duration of the call (e.g., until both the caller and callee have hung up or otherwise ended the call/communication session).

The rendering instructions field 420 may carry instructions that are used by the O/S 228 of the callee's user device to render a particular set of applications (or icons) from among the plurality of applications (or icons) stored in memory 208. In some embodiments, the rendering instructions field 420 may be specifically related to the visual presentation and manner in which particular GUI elements are presented via the user interface (e.g., rules describing whether lines are hidden or shown, line colors, line weights, icon placements, color schemes, etc.). The presentation instructions 424 may also impact the visual presentation of GUI elements and other visual aspects of the user interface. The presentation instructions 424 may, therefore, supplement or enhance the rendering instructions 420. In some embodiments, the rendering instructions 420 may be responsible for controlling the presentation of particular application icons on a home screen of the O/S 228 whereas the presentation instructions may be responsible for controlling the presentation of elements within a particular application. For instance, the rendering instructions 420 may control whether an icon for a communication or call application is presented on a home screen of the O/S 228 whereas the presentation instructions may control the type of information presented and how such information is presented within the communication or call application. The presentation instructions 424 may further define that the user device automatically open and present a particular screen for the communication or call application when the incoming all notification message is received.

In a similar vein, the notification instructions field 428 may provide instructions related to the way that notifications are presented via the user interface. As with the presentation instructions 424, the notification instructions 428 may define which application(s) are opened automatically for an incoming call notification message and what type of data is presented with that application. In addition to the presentation instructions 424, the notification instructions 428 may further provide instructions for the user device to provide audible, visual, and/or haptic alerts via the user device to notify the callee that an incoming call message is being received. As mentioned above, the instructions 420, 424, 428 may be collectively referred to as a set of presentation instructions. This set of presentation instructions may be modified based on a determined persona associated with a call and may further define which applications (or icons) are presented via a user interface of the callee's user device. These instructions may be incorporated directly into a call notification message, appended to a call notification message, included in a header of a call notification message, or the like. Alternatively or additionally, the set of presentation instructions may be sent to the callee's user device via a separate data channel than is being used to carry the call notification message. Said another way, any type of data channel or conduit may be used to provide the set of presentation instructions from the service 116 to the callee's user device. As can be appreciated, if the callee's user device performs all of the functions of the service 116, then certain data fields of the data structure 400 may become unnecessary.

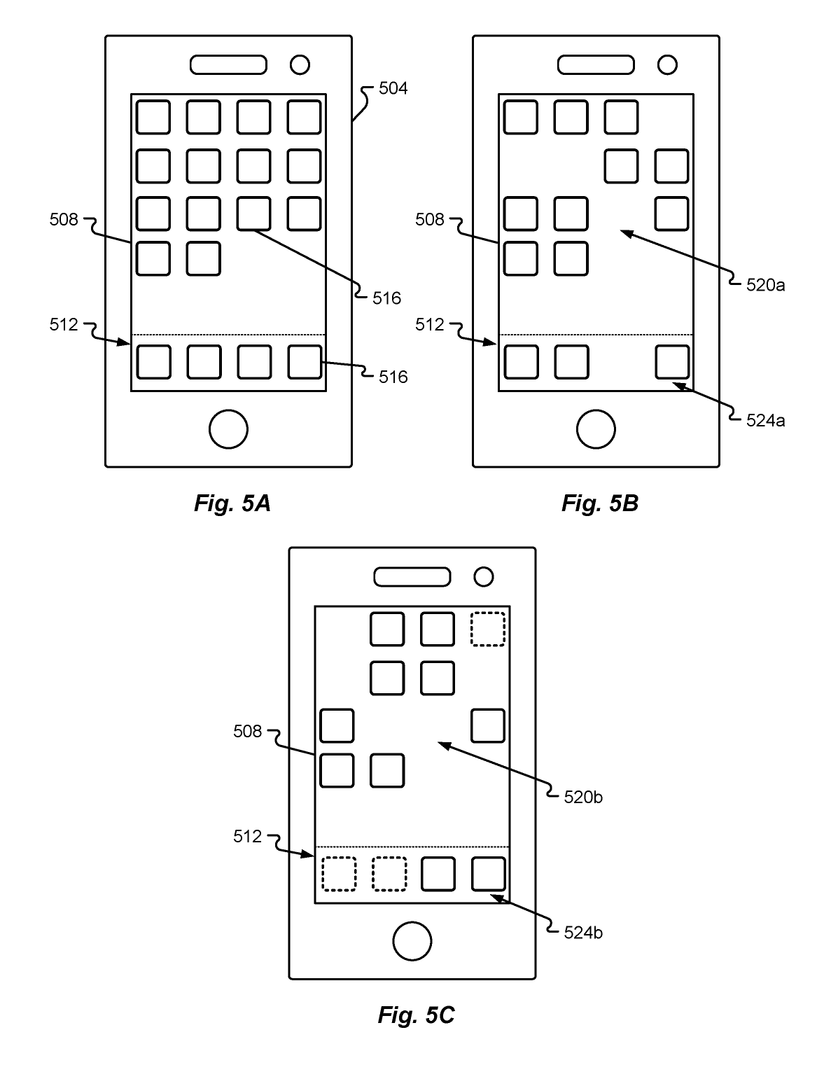

FIGS. 5A-C depict various possible presentation scenarios or outputs that may be provided on a user interface of a user device according to embodiments of the present disclosure. As shown in FIG. 5A, a user device 504 (which may be similar or identical to user device 104, 108) includes a combination user input/output device 508 in the form of a touch-sensitive display screen. The screen 508 may be partitioned (depending upon display preferences associated with the O/S 228) such that a portion of the screen 508 persistently displays predetermined icons 516 for some applications in a home screen portion 512 whereas other icons 516 are presented in another portion of the screen 508. In some embodiments, the particular icons 516 presented in the home screen portion 512 may be defined by the user and the arrangement of icons in the other portion of the screen 508 may also be defined by the user. FIG. 5A depicts, as an example, a default presentation of icons on the screen 508 when no incoming call notification message is received and/or when an incoming call notification message is received without a particular persona being associated therewith. As such, a full compliment of icons 516 are presented in the various portions of the screen 508. This view of icons 516, their color, shape, and general arrangement may also be defined by the O/S 228 and/or the presentation preferences 224 driving a presentation behavior of the O/S 228. In this view a user may be allowed to access a particular application by selecting an icon 516 associated with that application. Upon selection, the view of the screen 508 may change such that the application-specific preferences 232 for the selected application are used to render additional data and/or graphics for the selected application. If a “home” button or icon is selected, the view may return to the default O/S presentation of icons as shown in FIG. 5A until another icon is selected or until an incoming call notification message is received.

Referring now to FIG. 5B, a second presentation scenario is depicted. The second presentation scenario may be similar to the first presentation scenario except that the second presentation scenario may be used when a first incoming call is received that has been determined to be associated with a first persona. This determination of persona for the call may be made locally at the user device 504 or it may be made remotely at the service 116 and communicated to the user device 504 and conveyed to the user device through a call notification message.

The second presentation scenario shows that screen 508 as displaying a first set of icons 520a, 524a that is not entirely inclusive or all icons 516 that would otherwise be displayed under default conditions. In some embodiments, the first set of icons 520a, 524a may adjust icons presented in the home screen portion 512 and/or in the other portion of the screen 508. As an example, if the incoming call is determined to be associated with a work persona, then applications associated with the work persona may have their icons 516 presented as part of the first set of icons 520a, 524a whereas other icons associated with applications not assigned to the work persona may be completely hidden or removed from presentation.

FIG. 5C depicts a third presentation scenario in accordance with embodiments of the present disclosure. The third presentation scenario may be used when an incoming call is received that is determined to be associated with a second persona (e.g., different than the first persona). As compared to the second presentation scenario, the third presentation scenario may render a different or second set of icons 520b, 524b that is different from the first set of icons 520a, 524a and that is different from the full compliment of icons 516 that are presented in a default condition. The icons in the second set of icons 520b, 524b may be arranged in the same position as in the first presentation scenario, but hidden/obfuscated from view. Alternatively, one or more icons 516 may be rearranged on the screen 508. As shown in FIG. 5C, one or more icons in the home screen portion 512 may also be hidden/obfuscated from view. As an example, if the incoming call is determined to be associated with a personal persona (e.g., non-work persona), then the applications associated with the personal persona may have their icons 516 presented as part of the second set of icons 520b, 524b whereas other icons associated with other applications may be hidden or removed from presentation.

Without departing from the scope of the present disclosure, there may be one or more icons that belong to both the first and second sets of icons. For example, a communication or call application may be associated with both a first and second persona, which means that the icon for that particular application may be presented in both the first, second, and third presentation scenarios. It may be possible, however, that certain data for the communication nor call application (e.g., personal contacts) is not presented during the second presentation scenario because the second presentation scenario is associated with a work persona and then other data for the communication or call application (e.g., work contacts) is not presented during the third presentation scenario (e.g., the personal persona). Any or all of these persona-based presentation behaviors may be customizable or user-configurable vis-à-vis modification of the various instructions and rules stored in memory 208, 308.

In some embodiments it may be possible to apply different color schemes to icons of applications belonging to a particular set of icons for a determined persona. Consider the following example, a first color scheme (e.g., blue) may be applied to a first persona (e.g., business) such that the O/S background color and/or the color of the icons belonging to the set of icons assigned to the first persona have the first color scheme applied thereto. The other icons not belonging to the “business” icons may not have the first color scheme applied thereto when a user device is involved in a call having the first persona assigned thereto. On the other hand, a second color scheme (e.g., red) may be applied to a second persona (e.g., personal) such that the O/S background color and/or the color of the icons belonging to the set of icons assigned to the second persona have the second color scheme applied thereto. The other icons not belonging to the “personal” icons may not have the second color scheme applied thereto. By utilizing the application of color schemes, a user can quickly view their user interface and determine whether a call has been assigned to a particular persona or whether the call is not assigned to a persona.

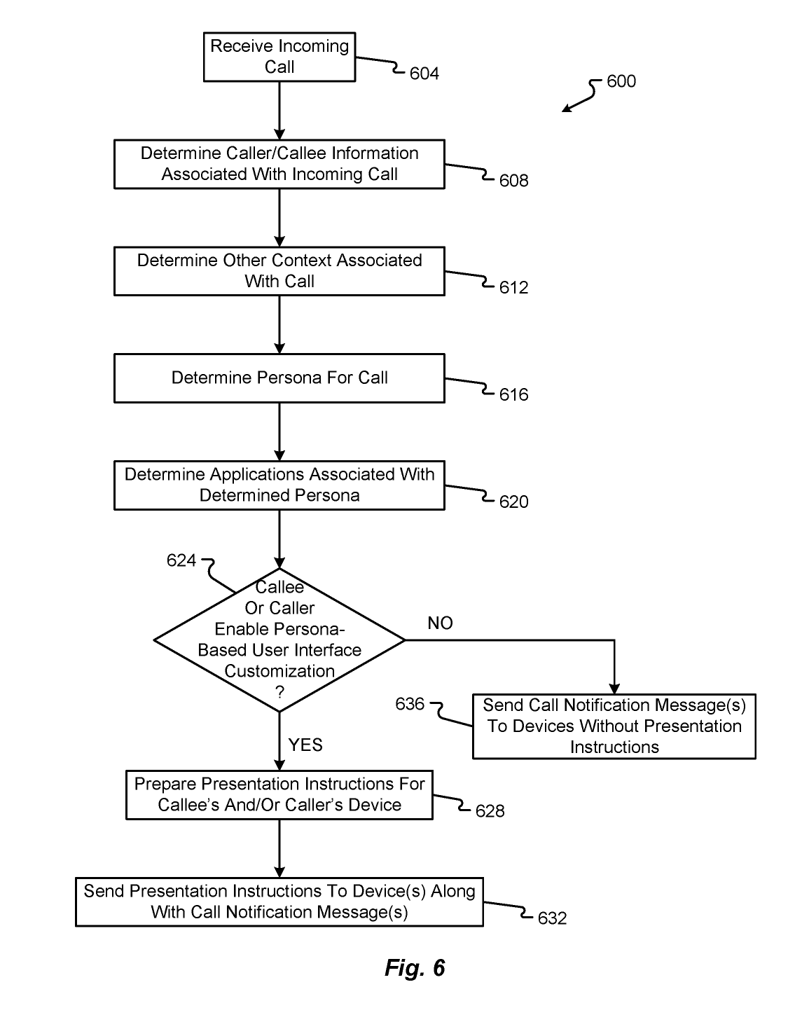

With reference now to FIG. 6, an illustrative method 600 of providing a persona presentation service 116 will be described in accordance with embodiments of the present disclosure. The method 600 begins when an incoming call (or call notification message) is received at a server (step 604). In some embodiments, the server receiving the incoming call notification message may correspond to a server executing the persona presentation service 116 and may be situated between a caller's user device and callee's user device within a communication network 112. Thus, the call notification message may be received at a communications interface 312. As a more specific example, the server receiving the incoming call notification message may be operating at a mobile network core or IMS core.

The method continues with the server determining caller and/or callee information associated with the incoming call notification message (step 608). In some embodiments, persona identification instructions 320 can be used to parse the incoming call notification message to extract the caller and/or callee identification information along with any other information that maybe used to identify the parties of the call and/or their user devices.

The method further continues by determining other context information associated with the call (step 612). In some embodiments, the persona identification instructions 320 are further used to determine one or more of: a location of the callee's user device, a location of the caller's user device, a time of day, a day of week, whether the caller and/or callee are scheduled for vacation, or combinations thereof. The caller and/or callee information possibly along with context information may be used to determine a persona for the call (step 616). In some embodiments, the server may utilize the persona identification instructions 320 to determine a persona for the call along with a confidence score associated with its determination. The confidence score may be calculated based on a number of factors including whether or not the caller corresponds to a particular known caller already positively identified as being associated with a particular persona, whether or not the caller corresponds to a user not positively identified as being associated with a particular persona but who has been observed as a particular type of contact, whether certain factors weigh more heavily toward one persona or another (e.g., a call on a weekend is more likely to be a personal call whereas a call during working hours on a weekday is more likely to be a work call), whether the callee is currently scheduled for a work meeting or personal meeting, whether the caller is currently scheduled for a work meeting or personal meeting, whether the callee and/or caller are currently located at a known place of business or a known private residence, etc. The more factors that weigh in favor of a specific persona may contribute to a higher confidence score for determining that specific persona as being associated with the call. If the confidence score is not above a predetermined threshold, then there may be no persona determined for the call and a default presentation may be provided to via the caller and/or callee's user device.

However, if a persona is determined to be associated with the incoming call, then the method continues with the server determining one or more applications that are associated with the determined persona (step 620). Applicant's associated with a determined persona may be different for a caller than a callee. For instance, a caller may have a first set of applications associated with a determined persona (e.g., a business persona) whereas a callee may have a second set of applications, which are different from the first set, associated with the determined persona (e.g., the business persona). This step may be performed with reference to presentation rule(s) 324 and/or the available applications for presentation 340. The method then continues by determining whether or not the callee and/or caller has enabled persona-based user interface customization features (step 624). If the answer to this query is no, then the method continues with the server sending the call notification message(s) to the callee's user device without any presentation instructions included therein (step 636).

On the other hand, if the query of step 624 is answered positively, then the method will continue with the server preparing a set of presentation instructions for conveyance to the callee's user device and/or caller's user device as appropriate (step 628). If both the callee and caller have enabled persona-based user interface customization settings, then two sets of presentation instructions may be prepared in this step (e.g., one set for the caller's device and another set for the callee's device). The set of presentation instructions may include one or more of presentation rules 324, GUI rendering instructions 332, notification preferences 336. The set of presentation instructions may be conveyed to the appropriate device(s) along with the call notification message(s) (step 632). As an example, the set of presentation instructions may be incorporated within the call notification message, included in a header of the call notification message, and/or transmitted as an attachment to the call notification message. The messaging instructions 328 may be used by the server to determine how to include the set of presentation instructions with the call notification message. Moreover, the set of presentation instructions and the call notification message may be transmitted to the callee's and/or caller's user device via the communication interface 312.

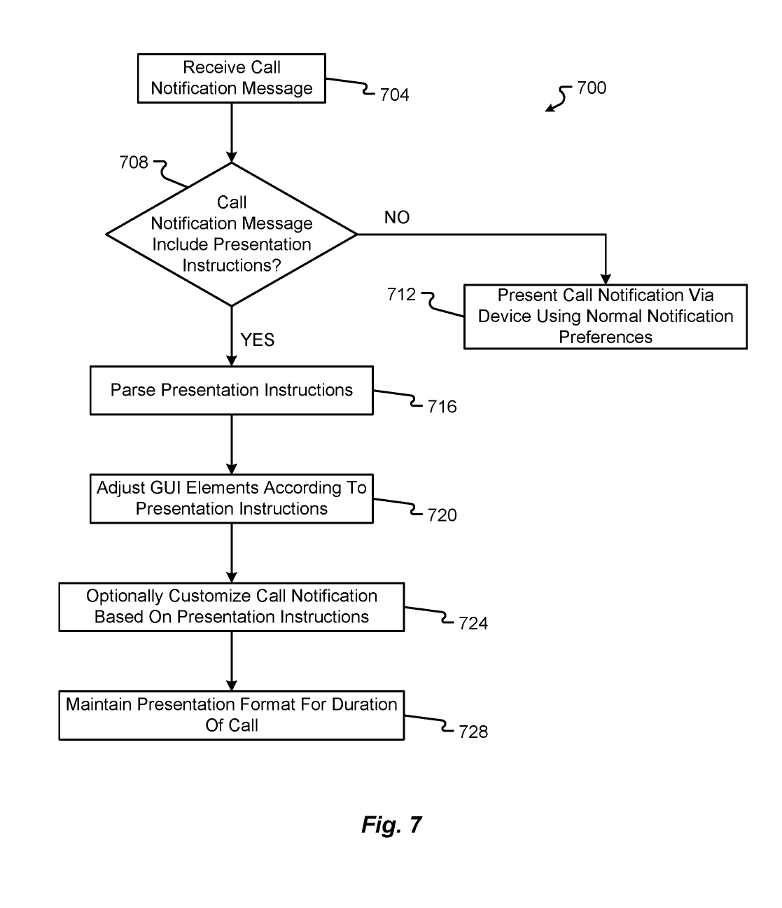

With reference now to FIG. 7, a method 700 of operating a user device to facilitate a persona-based user interface customization will be described in accordance with at least some embodiments of the present disclosure. The method 700 may be executed at a caller's user device, at a callee's user device, and/or at any other user device involved in a communication session (e.g., at a conference participant's user device). The method begins when a call notification message is received at the user device 104, 108 (step 704). In some embodiments, the call notification message is received at the callee's and/or caller's user device via the communications interface 212. The call notification message may be received as one or multiple messages transmitted over the communication network 112.

The call notification message is provided to the processor 204 where it is parsed and the decision is made as to whether or not the call notification message includes a set of presentation instructions (step 708). If the answer to this query is negative, then the method proceeds with the processor 204 presenting a default call notification via the user interface 220 of the user device (step 712). A default call notification may include a presentation of all applications (or icons associated therewith) on the screen 508. The default call notification may further include providing an audible alert and/or tactile alert via components of the user device, possibly in conformance with default presentation preferences 224 executed by the O/S 228.

If the query to step 708 is answered positively, then the method may continue with the processor 204 parsing the set of presentation instructions included in the call notification message (step 716). Based on the set of presentation instructions, the user device will adjust the GUI element presentation according to the set of presentation instructions, but still in accordance with the presentation preferences 224 (step 720). Optionally, the call notification may be customized based on the set of presentation instructions (step 724). As discussed in connection with FIGS. 5A-C, the GUI elements (e.g., icons, wireframes, etc.) can be repositioned in their presentation by the O/S 228, highlighted, hidden, obfuscated, or otherwise altered consistent with the persona determined by the server that transmitted the set of presentation instructions.

The method may further include maintaining the presentation format implemented in step 720 for the duration of the call (step 728). This presentation format may be modified or turned off if the user selects an option indicating such a modification. Alternatively, the presentation format may only be maintained for the duration of the call notification itself.

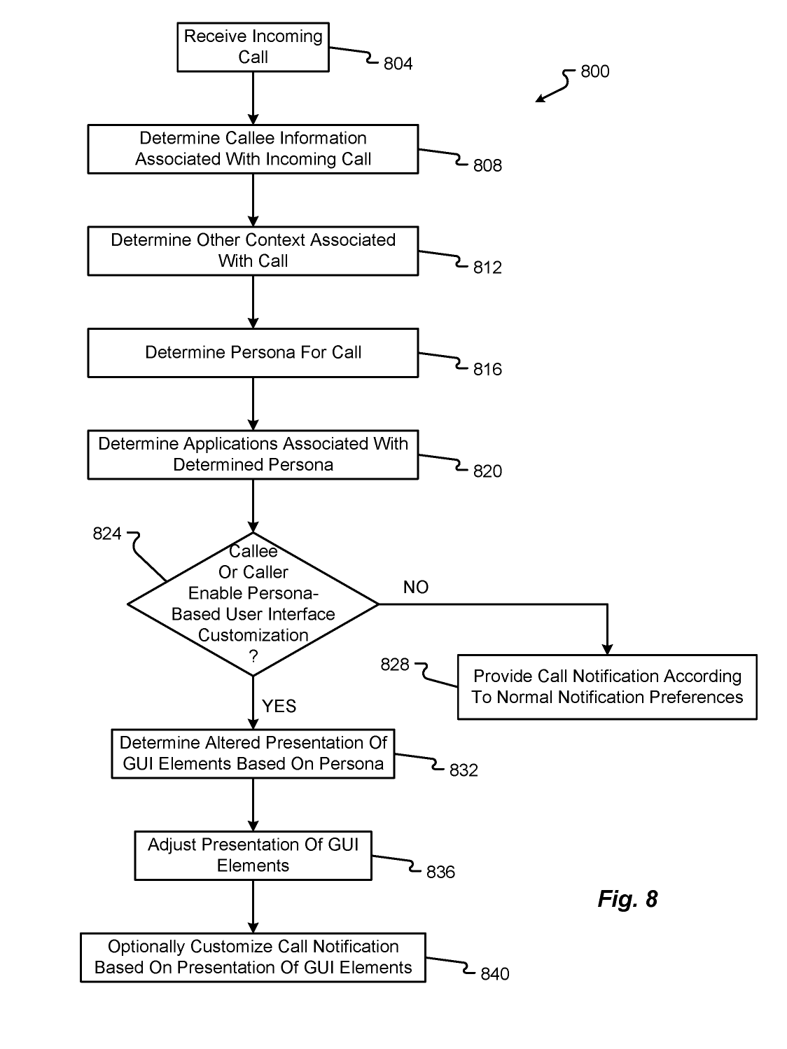

With reference now to FIG. 8, an alternative method 800 of operating a user device will be described in accordance with at least some embodiments of the present disclosure. As compared to the methods of FIGS. 6 and 7, the method 800 corresponds to a method in which some or all of the analytics and decisions are made at the user device (e.g., rather than having at least some processing performed in the mobile network core by a server). The method begins when a user device receives an incoming call, places an outbound call, receives a call notification, and/or transmits a call notification via its communication interface 212 (step 804). The method continues with the user device invoking persona identification instructions to determine caller and/or callee information associated with the incoming call (step 808). The user device may further invoke the persona identification instructions to determine a context associated with the call (step 812).

Based on the determination of steps 808 and 812, the method continues by determining a persona for the call (step 816). If a persona cannot be positively identified (e.g., within a predetermined confidence threshold), then a default persona may be applied, which does not result in any personalized or special presentation of icons or applications by the O/S 228. However, if the call is determined to have a persona associated therewith that is different from a default persona, then the method proceeds by determining which applications (or icons) are associated with the determined persona (step 820). This determination may be made with reference to presentation rules 324 and a listing of applications available for presentation 340. The listing of applications available for presentation may further include an identifier of personas associated with a particular application. As discussed in connection with method 600, the caller may have a different set of applications associated with a persona as compared to a callee. Thus, a first set of applications may be associated with a particular persona (e.g., a personal persona) for the caller whereas a second set of applications may be associated with the same persona for the callee, where the first and second sets of applications have at least one different application between them.

The method continues by determining whether the callee and/or caller has enabled persona-based user interface customization features (step 824). If the answer to this query is negative, then the incoming call and/or outbound call is alerted using normal call notification preferences (step 828). On the other hand, if the query of step 824 is answered positively, then the user device will determine an altered presentation of GUI elements based on the determined persona (step 832). As can be appreciated, this may occur at the callee's user device, at the caller's user device, at both the callee and caller's user device, or at any other user device involved in the communication session for which the persona has been determined. The presentation of GUI elements may be altered by removing particular icons from view, hiding particular icons from view, highlighting particular icons for enhanced viewing, moving positions of icons, etc. (step 836). The method may further include optionally customizing a call notification for the incoming call based on the determination of the persona and/or based on a presentation of the GUI elements (step 840). As a non-limiting example, the determined persona may dictate that particular icons for applications associated with the persona are displayed on a left side of the user interface and the right side of the user interface is used to provide a graphical element associated with the incoming call notification (e.g., a “call alert” message and options for responding thereto). In this way the user interface can be customized specific to the determined persona, thereby enabling the user to access the various applications associated with that persona in a more efficient way (e.g., due to the limiting screen space offered by most user devices). Similar modifications can be performed on the caller's user device without departing from the scope of the present disclosure.

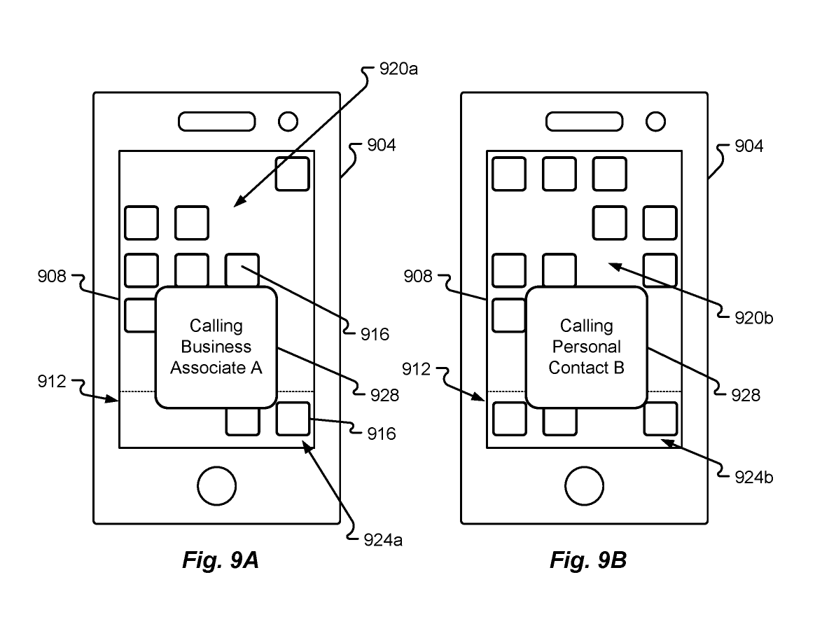

With reference now to FIGS. 9A and 9B, examples of a caller's user interface will be described in accordance with at least some embodiments of the present disclosure. FIG. 9A depicts an example of a caller's device 904 when the user interface is personalized for a business persona (e.g., to accommodate an outbound business call) whereas FIG. 9B depicts an example of caller's device 904 when the user interface is personalized for a personal persona (e.g., to accommodate an outbound personal call). Similar to FIGS. 5A-C, the user device 904 may include a screen that includes a home screen portion 912 and another portion of the screen 908 that is not inclusive of the home screen portion 912. Icons 916 may be presented on the screen 908 and home screen portion 912 in a particular manner when no outbound calls are being dialed or sent. In such a scenario, all of the applications for the home screen portion 912 and remainder of the screen 908 may be presented to the user.

However, when the user places a call to a business associate and the outbound call is determined to be associated with a business persona, the user interface may be adjusted as shown in FIG. 9A. Specifically, one or more icons 916 from the home screen portion 912 and/or other screen 908 may be removed, obfuscated, hidden, or otherwise made less visible as compared to other icons 916. The remaining icons 916 may correspond to icons associated with the caller's business persona. In some embodiments, the remaining icons 916 may belong to a first set of icons 920a, 924a that are associated with a first set of applications (e.g., the business persona applications). Moreover, a dialog box 928 may be presented in which call information for the callee is presented to the caller while the caller receives ringback and/or while the caller is finally connected with the callee and a communication session ensues.

FIG. 9B, in comparison, shows the user interface when the same caller places a personal call and the call is determined to be associated with a personal persona. In this scenario, a second set of icons 920b, 924b are presented via the user interface rather than presenting the first set of icons. The second set of icons 920b, 924b may correspond to a second set of applications that are associated with the caller's personal persona. As can be seen, the second set of icons 920b, 924b may be presented in different locations on the user interface as compared to the first set of icons 920a, 924a. Further still, the call dialog box 928 may present information about the callee, which may correspond to a personal contact rather than a business contact of the caller. In this scenario, the icons and associated applications particularly useful for the caller in personal situations may be presented via the user interface of the device 904 and the other icons and associated applications more suited toward business calls may be hidden, obfuscated, or otherwise minimized from view/presentation.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A mobile network core, comprising:
a communication interface that enables receipt of incoming calls;
a microprocessor; and
memory that stores instructions that, when executed by the microprocessor, enable the microprocessor to identify an incoming call as being associated with a first persona or a second persona and, based on whether the incoming call is identified as being associated with the first persona or the second persona, automatically causes a user interface of a mobile device associated with the incoming call to present a particular set of applications from a plurality of applications to a user of the mobile device.

2. The mobile network core of claim 1, wherein the first persona comprises a personal persona and wherein the second persona comprises a non-personal persona and wherein the mobile device is associated with a callee or caller identified in the incoming call.

3. The mobile network core of claim 2, wherein the second persona comprises a business persona, wherein a first set of applications is automatically presented via the user interface in connection with determining that the incoming call is associated with the first persona, wherein a second set of applications is automatically presented via the user interface in connection with determining that the incoming call is associated with the second persona, and wherein the first set of applications comprises at least one application that is not in the second set of applications.

4. The mobile network core of claim 3, wherein the set of applications are automatically presented via the user interface along with a notification of the incoming call and wherein one or more business rules are applied to the incoming call in response to determining that the incoming call is associated with the business persona.

5. The mobile network core of claim 4, wherein the notification of the incoming call comprises an alert, wherein the business rules cause a network feature to be applied to the incoming call, and wherein the presentation of the set of applications comprises rendering one or more graphical user interface (GUI) elements associated with each application in the set of applications.

6. The mobile network core of claim 1, wherein the incoming call is identified as being associated with the first persona or the second persona based, at least in part, on an identification of a caller or callee associated with the incoming call.

7. The mobile network core of claim 1, wherein the first persona corresponds to a default persona that is identified as being associated with the incoming call in an event where the incoming call cannot positively be associated with the first persona or the second persona.

8. The mobile network core of claim 1, wherein the incoming call comprises at least one of an incoming voice call, an incoming video call, an incoming chat, and an incoming social network communication.

9. The mobile network core of claim 1, wherein the user corresponds to a caller that initiates the incoming call.

10. The mobile network core of claim 1, wherein the user corresponds to a callee that is an intended recipient of the incoming call.

11. A non-transitory computer readable medium comprising a set of instructions stored therein which, when executed by a processor, causes the processor to provide a persona-based customization of information via a user device involved in a communication session by:
receiving, at a mobile network core, a notification of an incoming call for at least one callee;
determine whether the incoming call is associated with a first persona or a second persona for the at least one callee or at least one caller that is placing the incoming call;
based on whether the incoming call is identified as being associated with the first persona or the second persona, generate a set of presentation instructions for a user device associated with the incoming call, wherein the set of presentation instructions cause the user device associated with the incoming call to present a particular set of applications from a plurality of applications via a user interface of the user device;
incorporate the set of presentation instructions into a message; and
transmit the message to the user device via a mobile communication network.

12. The non-transitory computer readable medium of claim 11, wherein the set of presentation instructions include instructions which cause the user device to render only icons associated with the particular set of applications.

13. The non-transitory computer readable medium of claim 12, wherein the set of presentation instructions further include instructions which cause the user device to hide icons associated with applications not belonging to the particular set of applications.

14. The non-transitory computer readable medium of claim 11, wherein the first persona comprises a personal persona and wherein the second persona comprises a non-personal persona and wherein the mobile device is associated with a callee or caller identified in the incoming call.

15. The non-transitory computer readable medium of claim 14, wherein the second persona comprises a business persona, wherein a first set of applications is automatically presented via the user interface in connection with determining that the incoming call is associated with the first persona, wherein a second set of applications is automatically presented via the user interface in connection with determining that the incoming call is associated with the second persona, and wherein the first set of applications comprises at least one application that is not in the second set of applications.

16. The non-transitory computer readable medium of claim 15, wherein the set of applications are automatically presented via the user interface along with a notification of the incoming call and wherein at least one icon associated with an application not belonging to the set of applications is hidden from presentation via the user interface.

17. The non-transitory computer readable medium of claim 11, wherein the incoming call is identified as being associated with the first persona or the second persona based, at least in part, on an identification of a caller or callee associated with the incoming call.

18. A method, comprising:
receiving a notification of an incoming call for at least one callee, wherein the incoming call is initiated by at least one caller;
determining whether the incoming call is associated with a first persona or a second persona for the at least one callee or the at least one caller;
based on whether the incoming call is identified as being associated with the first persona or the second persona, causing a mobile device to present a particular set of applications from a plurality of applications via a user interface of the user device, wherein an application not belonging to the particular set of applications has an associated icon hidden from presentation via the user interface.

19. The method of claim 18, wherein the application not belonging to the particular set of applications has its associated icon hidden for a duration of the call.

20. The method of claim 18, further comprising:
providing a notification via the user interface that indicates whether the incoming call is identified as being associated with the first persona or the second persona, wherein the first persona comprises a personal persona, wherein the second persona comprises a non-personal persona, and wherein the mobile device is associated with a callee or caller identified in the incoming call.
